(19) United States
(12) Patent Application Publication
(10) Pub. No.: US 2014/0327796 A1
(43) Pub. Date: Nov. 6, 2014

(54) METHOD FOR ESTIMATING CAMERA RESPONSE FUNCTION

(71) Applicant: NATIONAL CHUNG CHENG UNIVERSITY, CHIAYI COUNTY (TW)

(72) Inventors: HUEI-YUNG LIN, CHIA-YI (TW); JUI-WEN HUANG, TAICHUNG CITY (TW)

(73) Assignee: NATIONAL CHUNG CHENG UNIVERSITY, CHIAYI COUNTY (TW)

(21) Appl. No.: 13/875,453

(22) Filed: May 2, 2013

(51) Int. Cl. H04N 5/235

(52) U.S. Cl. CPC H04N 5/2351
USPC 348/254

(57) ABSTRACT

A method for estimating image conversion parameters is revealed. Firstly, using an image capturing unit to capture at least one captured image of an object to an image processing unit for calculation. The image processing unit can take linear brightness change of single captured image to estimate the image conversion parameters, also can take comparison of linear and non-linear images to estimate the image conversion parameters, further can take the difference of exposure quantities to estimate the image conversion parameters. Therefore, the estimation of the image conversion parameters can be finished well and easily.

### FIELD OF THE INVENTION

The present invention relates generally to a method for estimating image parameters, and particularly to a method for estimating image conversion parameters.

### BACKGROUND OF THE INVENTION

In general, a non-linear response function is often embedded in camera capabilities by the camera manufacturers, for adapting to the characteristics of the real scene with respect to the imaging devices, or to a non-linear correlation between the human vision system and the computer display. Under normal conditions, the brightness sensing capability and the brightness adaptability of human eyes can be better than the capability of cameras, for example, in a room with weak brightness, human eyes can identify each scene object in the room more obviously after staying for a while. However, the brightness detection of a camera is limited to a predetermined brightness range by a specific threshold of the image brightness sensing capability. For example, a camera detects an 8-bit pixel. That is, captured pixel values of an image captured into the camera will be zero while the radiance of an object image is lower than the specific threshold. The camera determines the detected brightness of the 8-bit pixel is full (such as the gray level of the 8-bit pixel is 255) while the real scene might be greater than 255. It means why occurs the brightness difference between the captured image of the camera and actual object seen by the human eyes, so the actual brightness information of the image is also different from what we expected in the next image process. Therefore, in terms of the relationship between the actual scene and the recorded image, it is not only helpful to build high dynamic range images (so-called as HDR images) for recorded images been close to the real brightness which human eyes can sense, but also good to provide actual image brightness information for continued image process and image analysis.

Referring to FIG. 1, it is shown as a non-linear correlation between the actual brightness information of the scene (such as radiance) and the recorded brightness information of the image (such as intensity). The non-linear correlation is indicated as image conversion parameters (CRF), and the CRF can illustrate the non-linear correlation as a curve for easily explaining the function for different brightness. For example, an 8-bit format image is stored as 256 gray levels to map the actual brightness (radiance), such as the mapping of 2⁸ to 2¹⁸. In order to match the characteristic and/or requirement of human eyes, the dark portion or luminous portion of the actual brightness is compressed. Therefore, the gradation of the compressed image is presented for showing the relationship of non-linear conversion from the raw image to the converted image.

However, different cameras with different requirements and/or from different manufacturers are embedded with different CRFs. That is, the CRF is needed to be modified dynamically according to the requirements, even each manufacturer has a CRF of his own for camera and peripheral product individually.

Accordingly, it is necessary to develop a simple and quick operation method for obtaining different series of the image conversion parameters respective to different cameras, such as different series of CRF parameters. Nowdays, in general, most of the applied techniques are to capture a plurality of image in one scene for estimating the CRF from sequential images at different exposure timing. It is not convenient for each consumer digital camera to estimate the CRF quickly.

According to the above issues, the present invention provides a method for estimating image conversion parameters from the captured image of a camera by using the edge feature in the captured image. Furthermore, it can calculate and analyze the captured image quickly by a single image capture, and it can be applied to each consumer digital cameras to obtain the image conversion parameters quickly.

### SUMMARY

An objective of the present invention is to provide a method for estimating image conversion parameters, which provides a parameter estimation quickly for consumer digital cameras.

Another objective of the present invention is to provide a method for estimating image conversion parameters, which simplifies the CRF estimation by using the edge feature in the captured image.

With one aspect, the present invention provides a method for estimating image conversion parameters applied to a camera including an image capturing unit and an image processing unit. Firstly, the image capturing unit captures a captured image from an object to the image processing unit. Then, a plurality of gray level values related to the analyzable block. Finally, the image processing unit estimates a plurality of image conversion parameters of the camera according to the gray level values. Therefore, the present invention can make the camera obtain the better image conversion parameters easily and quickly while the camera only captures one captured image for estimating image conversion parameters.

With another aspect, the present invention provides a method for estimating image conversion parameters applied to a camera including an image capturing unit and an image processing unit. Firstly, the image capturing unit captures a captured images from an object to the image processing unit, and converts the captured image into a non-linear image. Then, the image processing unit obtains first and second gray level values related to the captured image into a non-linear image. Next, comparing the first and second gray level values to obtain a comparison result. Finally, the image processing unit estimates a plurality of image conversion parameters of the camera according to the comparison result. Therefore, the present invention can make the camera obtain the better image conversion parameters easily and quickly while the camera only compares the edge feature in the linear and non-linear images for estimating image conversion parameters.

With another aspect, the present invention provides a method for estimating image conversion parameters applied to a camera including an image capturing unit and an image processing unit. Firstly, the image capturing unit captures a plurality of captured images with different exposure quantities from an object to the image processing unit. Then, the image processing unit obtains a plurality of gray level values related to the captured image. Next, merging the gray level values to obtain a plurality of merged parameters. Finally, the image processing unit estimates a plurality of image conversion parameters of the camera according to the merged parameters. Therefore, the present invention can make the camera obtain the better image conversion parameters easily while the camera only merging captured images for estimating the image conversion parameters.

### BRIEF DESCRIPTION OF THE DRAWINGS

FIG. 1 shows a diagram of the non-linear relationship according to the prior art;

FIG. 2 shows a diagram of a flowchart according to an embodiment of the present invention;

FIG. 3A shows a diagram of a captured image captured from a digital camera according to an embodiment of the present invention;

FIG. 3B shows a diagram of a analyzable block in a captured image according to an embodiment of the present invention;

FIG. 4 shows a diagram of a pixel intensity curve according to the embodiment of the FIG. 3B;

FIG. 5 shows a diagram of a CRF curve according to the embodiment of the FIG. 4;

FIG. 6 shows a diagram of a flowchart according to another embodiment of the present invention;

FIGS. 7A and 7C shows a diagram of a raw image and a pixel intensity curve thereof according to another embodiment of the present invention;

FIGS. 7B and 7D shows a diagram of a converted image and a pixel intensity curve thereof according to another embodiment of the present invention;

FIG. 8 shows a diagram of a CRF curve according to the embodiment of the FIGS. 7A and 7B;

FIG. 9 shows a diagram of a flowchart according another embodiment of the present invention;

FIGS. 10A-10C show three images with different exposure levels according to an embodiment of the present invention;

FIG. 11 shows a diagram of three pixel intensity curves according to the embodiment of the FIGS. 10A-10C;

FIG. 12 shows a diagram of a combined curve according to the embodiment of the FIG. 11;

FIG. 13 shows a diagram of a CRF curve according to the embodiment of the FIG. 12;

FIG. 14 shows a diagram of a flowchart according another embodiment of the present invention;

FIGS. 15A-15B show diagrams of the first raw and processed images and a CRF curve thereof according to another embodiment of the present invention;

FIGS. 16A-16B show diagrams of the second raw and processed images and a CRF curve thereof according to another embodiment of the present invention;

FIGS. 17A-17B show diagrams of the third raw and processed images and a CRF curve thereof according to another embodiment of the present invention;

FIG. 18A-18B show diagrams of the fourth raw and processed images and a CRF curve thereof according to another embodiment of the present invention; and

FIG. 19 shows a diagram of a combined CRF curve according to the embodiment of the FIGS. 15A-18B.

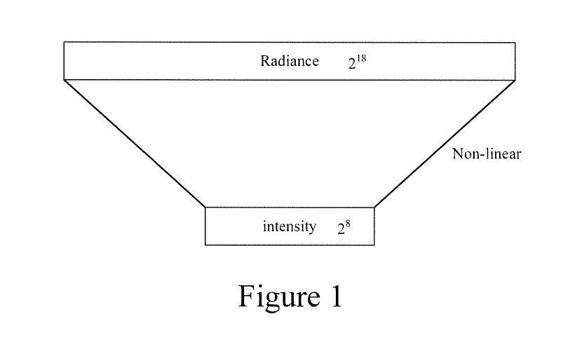

### DETAILED DESCRIPTION

In order to make the method and characteristics as well as the effectiveness of the present invention to be further understood and recognized, the detailed description of the present invention is provided as follows along with embodiments and accompanying figures.

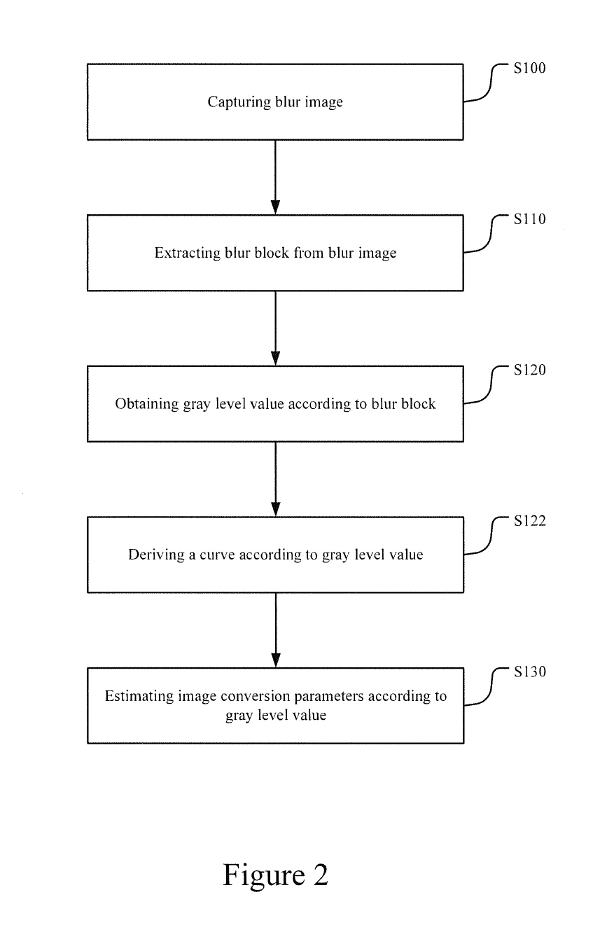

Referring to FIG. 2, a diagram of a flowchart according to an embodiment of the present invention is shown. A method for estimating image conversion parameters, which is applied for a camera including an image capturing unit (not shown) and an image processing unit (not shown), wherein the camera including the image capturing unit (not shown) and the image processing unit is well-known, so following content will no longer described any more. The steps for the method for estimating image conversion parameters are as follows.

Step S100: Capturing a blur image;

Step S110: extracting an analyzable block from captured image;

Step S120: obtaining a plurality of gray level values according to the analyzable block;

Step S122: deriving a curve according to the gray level values; and

Step S130: estimating image conversion parameters.

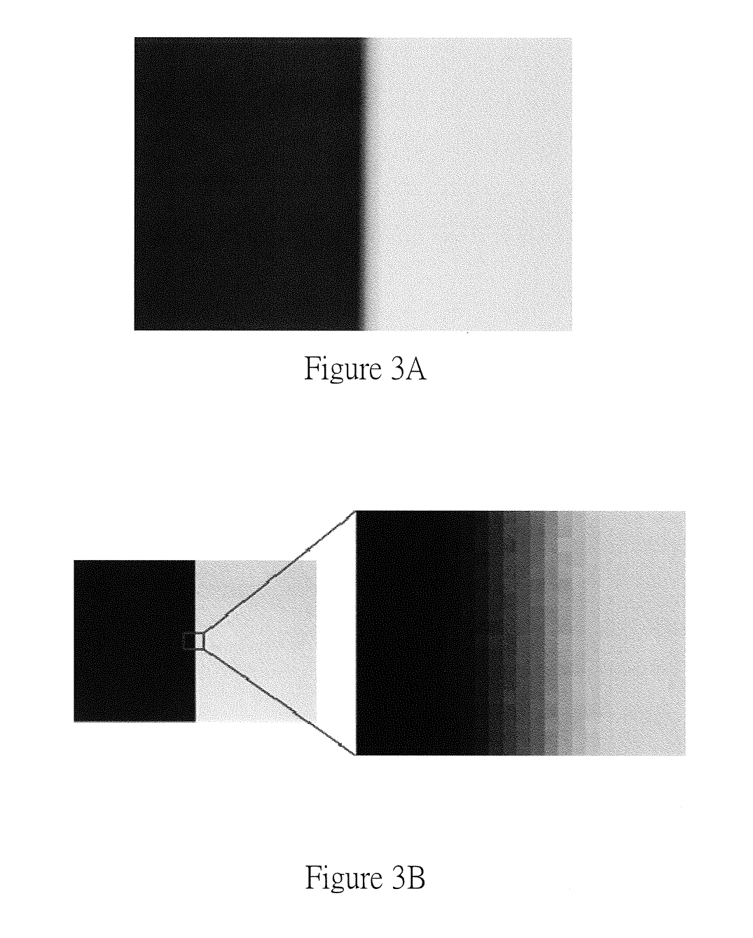

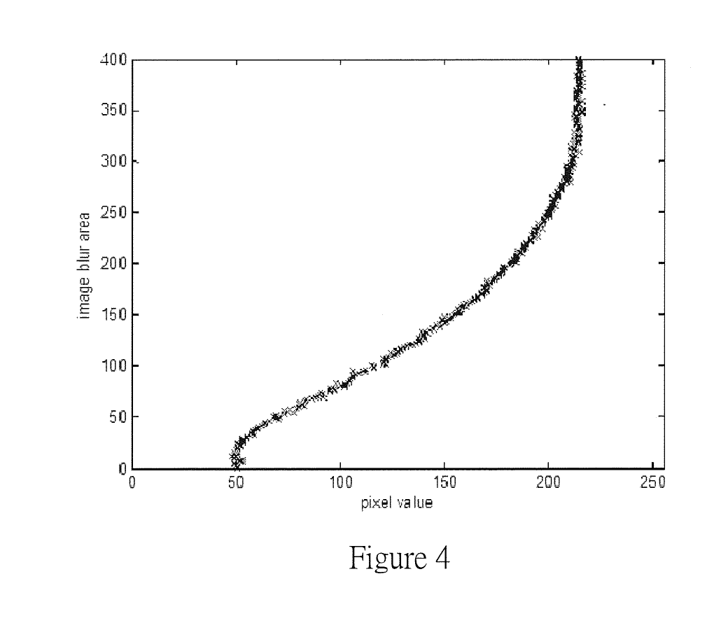

Referring to FIG. 3A, in the step S100, the image capturing unit captures an image, and the image is also called as the captured image. The captured image of the embodiment is a captured image containing a blur edge feature with different gray levels, such as 210 and 52. The captured image is transferred to the image processing unit. In this embodiment, the captured image is a blur image. Referring to FIG. 3B, in the step S110, an analyzable block is extracted from the captured image by the image processing unit, wherein the analyzable block has a lower gray portion and a high gray portion. The image processing unit extracts the analyzable block using a wavelet transformation manner, such as H. Tong, M. Li, H. Zhang, J. He, and C. Zhang. “Blur detection for digital images using wavelet transform.” In Proceedings of International Conference on Multimedia and Expo, 2004. Further, the image processing unit can extract the analyzable block using a block selecting manner for selecting a preferably analyzable block. Next to step S120, calculating the pixel intensity distribution of pixels in one row of the analyzable block to obtain the gray level values, so as to obtain the gray level values of the analyzable block. Then, referring to FIG. 4, a curve is obtained according to the gray level values in the step S122, wherein the values on the X-axis means pixel values, the values on the Y-axis means the blur image pixel location. That is, FIG. 4 shows the pixel intensity distribution of the analyzable block in the FIG. 3B, and it is converted by the conversion function embedded in the camera from the gray values of the pixels to the pixel intensity distribution.

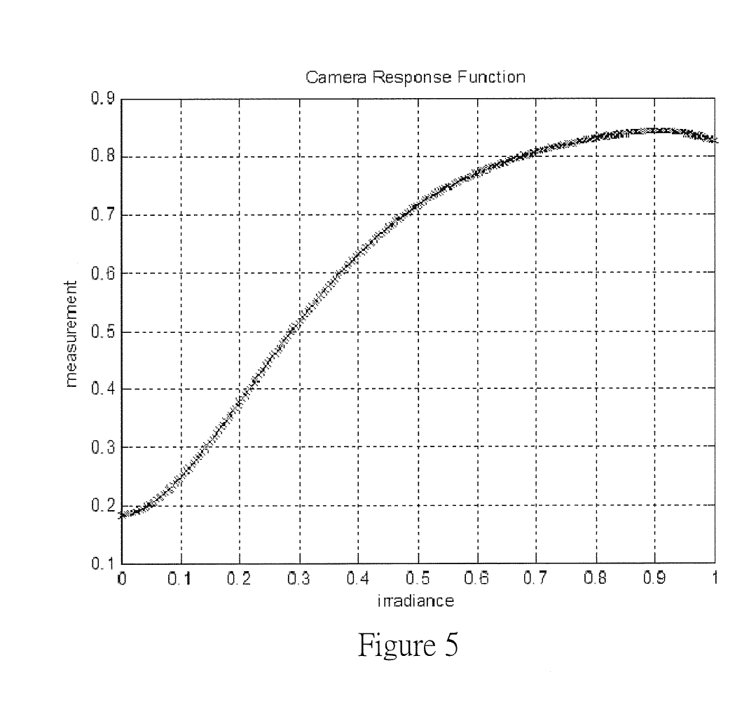

Continuously, in the step S130, the image processing unit can estimate the image conversion parameters (such as parameters of camera response function (CRF)) according to the curve obtained in the step S122 because the portion of the curve obtained in the step S122 shows a linear change of pixel values to pixel intensities. Referring to FIG. 5, the image processing unit normalizes the curve of the pixel intensity distribution of the analyzable block to the curve of CRF wherein the image processing unit converts the curve of the pixel intensity distribution using follow equation for obtaining a converted curve.

f(x)=p₁x⁵+p₂x⁴−p₃x³+p₄x²+p₅x+p₆, p₁·p₆=const (1)

Then, the image processing unit obtains the parameters of the CRF according to the converted curve. For example, as shown in the FIG. 5, the CRF is obtained as follow after line fitting:

f(x)=−6.169x⁵+17.92x⁴−19.03x³+7.878x²+0.058x+0.169

The blur edge feature occurs a linear change of the curve of the pixel intensity distribution so as to obtain the irradiance change of the object under photography. Therefore, the image processing unit can easily estimate the CRF parameters according to the irradiance change of the object under photography.

Accordingly, the present invention provides a method for estimating the CRF parameters to make a camera easily obtain the CRF parameters its own according to the linear change on the curve because the blur edge feature occurs a linear change of the curve of the pixel intensity distribution.

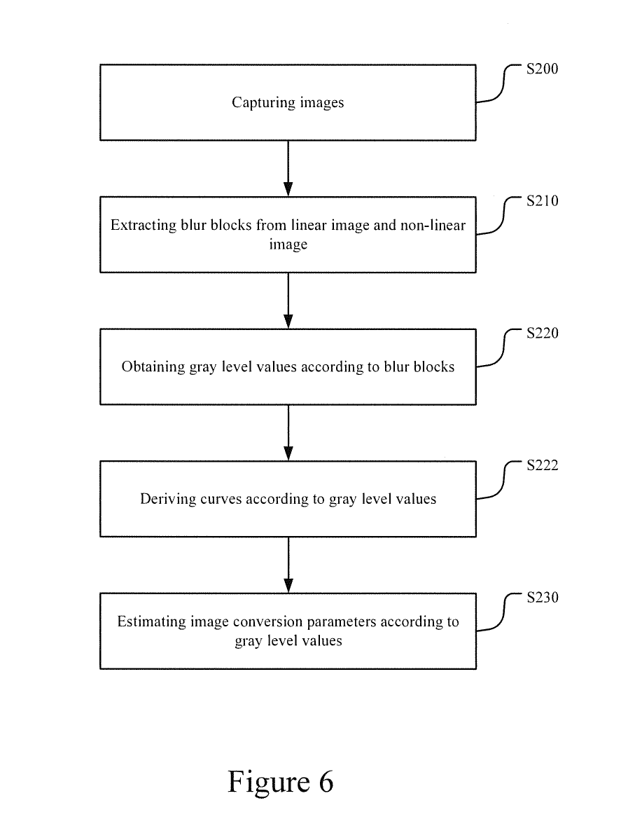

Referring to FIG. 6, a diagram of a flowchart according to another embodiment of the present invention is shown. A method for estimating image conversion parameters, which is also applied for a camera including an image capturing unit (not shown) and an image processing unit (not shown) for a linear image and a non-linear image. The steps for the method for estimating image conversion parameters are as follows.

Step S200: capturing images;

Step S210: extracting analyzable blocks from linear and non-linear images;

Step S220: obtaining gray level values according to the analyzable blocks;

Step S222: deriving curves according to the gray level values; and

Step S230: estimating image conversion parameters.

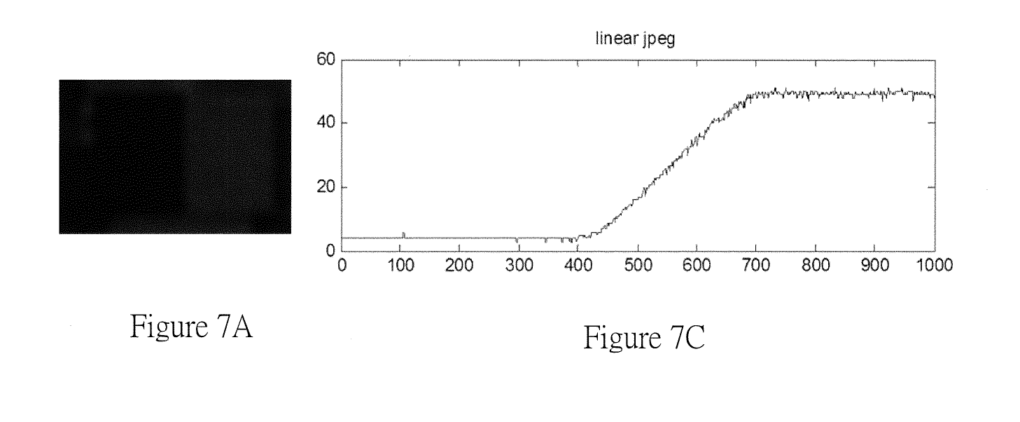

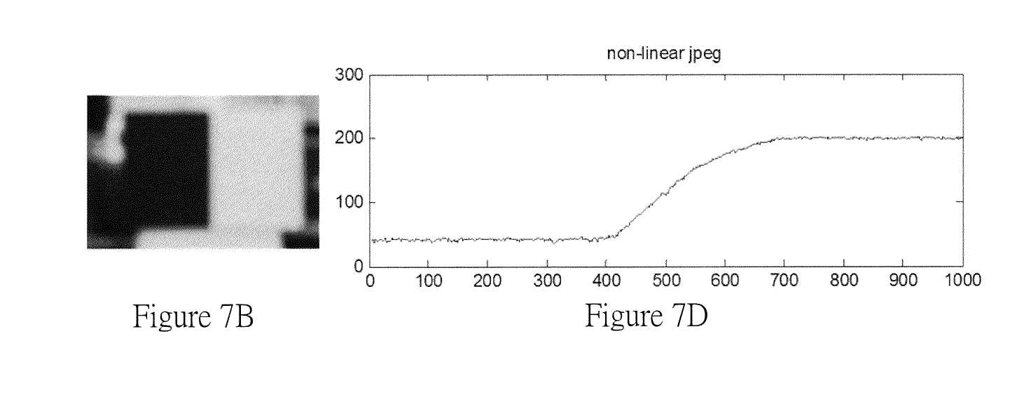

Referring to FIG. 7A, in the step S200, the image capturing unit captures a plurality of captured images. The captured images of the embodiment is a linear image and a non-linear image, and the linear image and the non-linear image both contain a blur edge feature of different gray level values respectively, such as 210 and 52. The captured images are transferred to the image processing unit. In the step S210, a first analyzable block is extracted from the captured image by the image processing unit, and a second analyzable block is extracted from the non-linear image. The first and second analyzable blocks have an edge feature between different intensity blocks, for example, a black-white edge feature between a black portion and a white portion, as being a lower gray portion and a high gray portion, respectively. The analyzable blocks in the embodiment are illustrated as the first and second analyzable blocks, but it is not limited to the analyzable blocks only can be the first and second analyzable blocks.

Next to step S220, the first and second analyzable blocks is analyzes for calculating the pixel intensity distribution in the first and second analyzable blocks to obtain the first and second gray level values, so as to obtain the first and second gray level values of the analyzable block. Then, referring to FIGS. 7C, 7D, first and second curves are obtained according to the gray level values in the step S222, wherein the values on the X-axis means pixel values, the values on the Y-axis means the blur image pixel location. That is, FIGS. 7C, 7D show the pixel intensity distribution of the analyzable blocks in the step S210, and the pixel intensity distribution is converted by the conversion function embedded in the camera from the gray values of the pixels to the pixel intensity distribution. The image processing unit extracts the analyzable block using a wavelet transformation manner, such as H. Tong, M. Li, H. Zhang, J. He, and C. Zhang. “Blur detection for digital images using wavelet transform.” In Proceedings of International Conference on Multimedia and Expo, 2004. Further, the image processing unit can extract the analyzable block using a block selecting manner for selecting a preferably analyzable block.

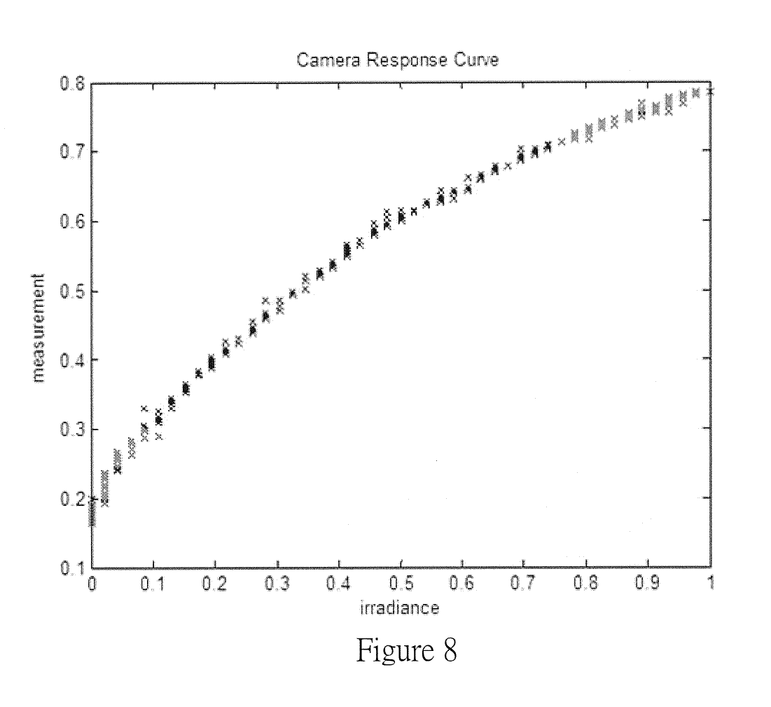

Continuously, in the step S230, the image processing unit can estimate the image conversion parameters, such as CRF parameters according to the comparison of the curves obtained in the step S222 because the linear image has a linear pixel intensity distribution and the non-linear image also has linear pixel intensity distribution in the portion segment. Referring to FIG. 8, the image processing unit obtains a CRF curve by comparing the pixel intensity curves of the captured image and non-linear image, wherein the blur edge feature occurs a linear change of the curve of the pixel intensity distribution so as to obtain the irradiance change (actual brightness change) of the object under photography. Therefore, the image processing unit can easily estimate the the CRF parameters according to the irradiance change of the object wherein the image processing unit converts the curve of the pixel intensity distribution using equation (1) for obtaining a converted curve. Then, the image processing unit obtains the parameters of the CRF according to the converted curve.

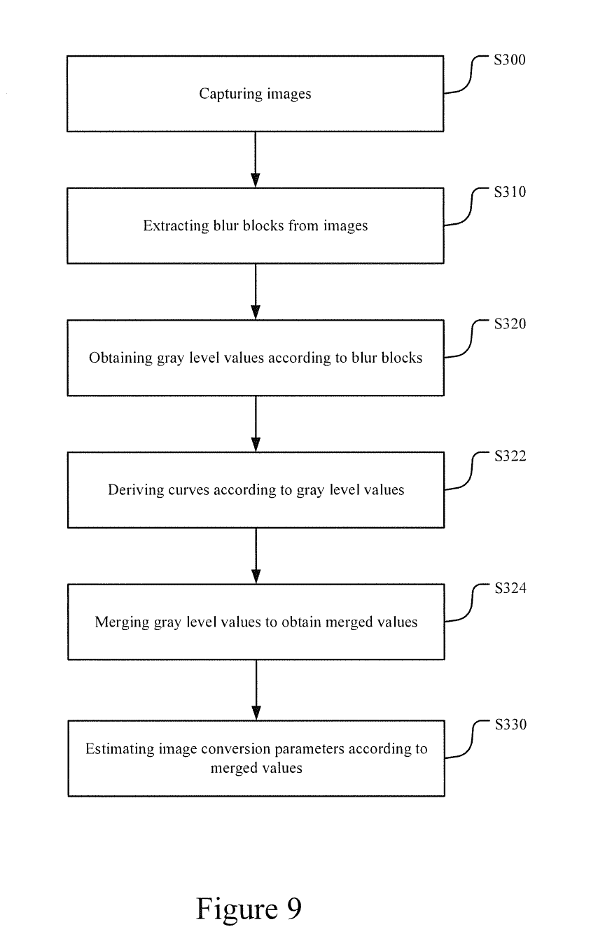

Referring to FIG. 9, a diagram of a flowchart according to another embodiment of the present invention is shown. A method for estimating image conversion parameters, which is also applied for a camera including an image capturing unit (not shown) and an image processing unit (not shown). The steps for the method for estimating image conversion parameters are as follows.

Step S300: capturing a plurality of captured images;

Step S310: extracting analyzable blocks from captured images;

Step S320: obtaining gray level values according to the analyzable blocks;

Step S322: deriving curves according to the gray level values;

Step S324: merging curves; and

Step S330: estimating image conversion parameters.

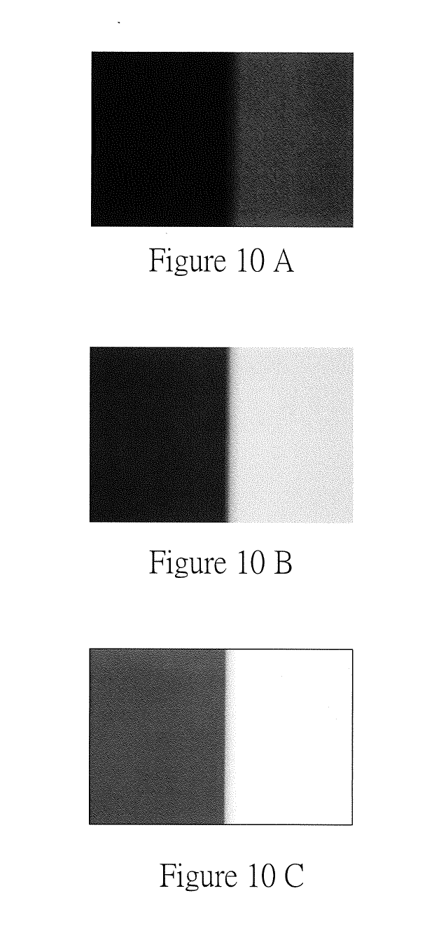

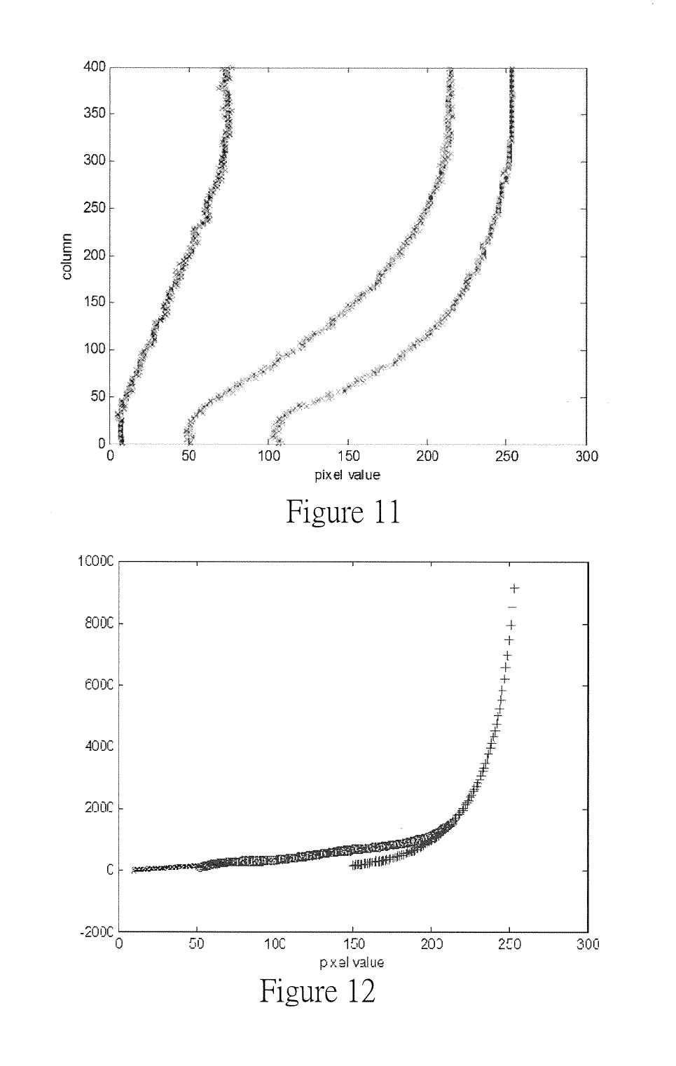

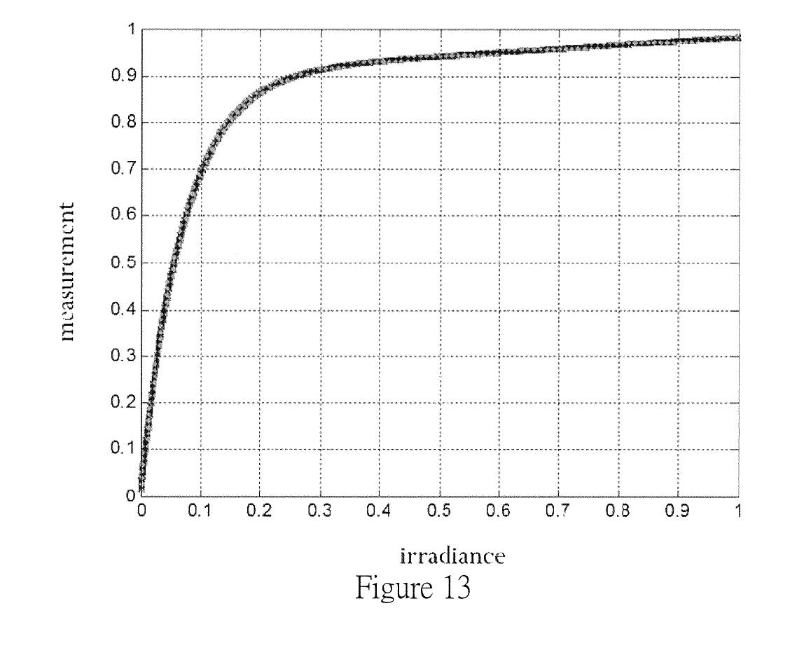

In step S300, the image capturing unit captures a plurality of images with different exposure quantities. Referring to FIGS. 10A-10C, the image capturing unit captures three images with different exposure quantities in this embodiment. The image in FIG. 10A has 0 exposure value (EV) that is lower exposure, and the image in FIG. 10B has 1 EV. The image in 10C has 3 EV that is higher exposure. The figures 10A-10C are captured images. In step S310, after the image capturing unit transfers the captured images to the image processing unit, a plurality of analyzable blocks are extracted from the captured images. The image processing unit extracts the analyzable block using a wavelet transformation manner, such as H. Tong, M. Li, H. Zhang, J. He, and C. Zhang. “Blur detection for digital images using wavelet transform.” In Proceedings of International Conference on Multimedia and Expo, 2004. Further, the image processing unit can extract the analyzable block using a block selecting manner for selecting a preferably analyzable block. In step S320, the gray level values of the analyzable blocks are obtained, next to step S322, the gray level values are converted to a plurality of curves as shown in FIG. 11. Different curves shows different exposure quantities and pixel intensity distribution of the analyzable blocks. In step S324, the curves generated in step S322 are merged to a combined curve related to the analyzable blocks. Finally, in step S330, the image processing unit estimating the image conversion parameters according to the combined curve. The step 330 is similar to step 130, so the image processing unit also normalizes the curve of the pixel intensity distribution of the analyzable block to be the CRF curve for obtaining the irradiance change of the object, as shown in FIG. 13. Therefore, the image processing unit can easily estimate the CRF parameters according to the irradiance change of the object under photography wherein the image processing unit converts the curve of the pixel intensity distribution using equation (1) for obtaining a converted curve. Then, the image processing unit obtains the parameters of the CRF according to the converted curve. Furthermore, the present invention can take linear images with different exposure quantities to compress into non-linear images for comparison and merge to obtain the image conversion parameters, as following detailed description.

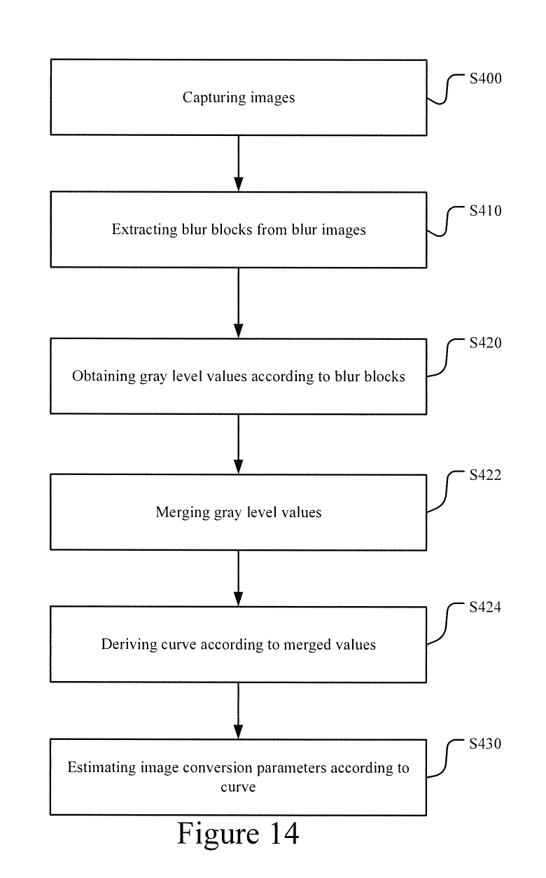

Referring to FIG. 14, a diagram of a flowchart according to another embodiment of the present invention is shown. A method for estimating image conversion parameters, which is also applied for a camera including an image capturing unit (not shown) and an image processing unit (not shown). The steps for the method for estimating image conversion parameters are as follows.

Step S400: capturing a plurality of images;

Step S410: extracting analyzable blocks from linear and non-linear images;

Step S420: obtaining gray level values according to the analyzable blocks;

Step S422: merging the gray level values;

Step S424: deriving a curve according to a merged gray level function; and

Step S430: estimating image conversion parameters.

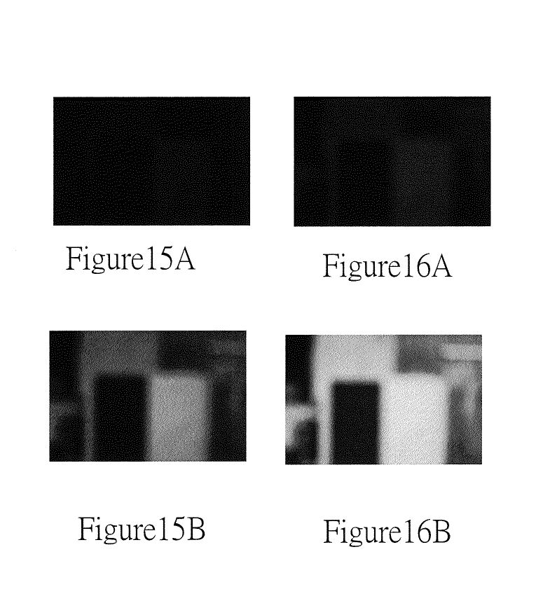

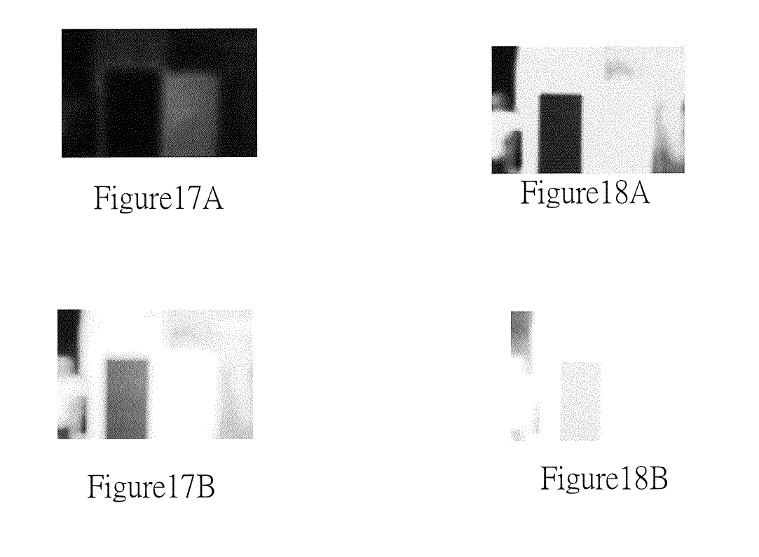

Due to the above steps S400-S430 similar to the combination of steps S200-S230 and steps S300-S330, the following description illustrates the steps S400-S430 simply. In the step S400, the image capturing unit captures a plurality of captured images to the image processing unit, the captured images contain linear images, as shown in FIGS. 15A, 16A, 17A and 18A, and non-linear images as shown in FIGS. 15B, 16B, 17B and 18B. As shown in FIGS. 15A, 16A, 17A, 18A and 15B, 16B, 17B, 18B, the linear images and the non-linear images have different intensity quantities, especially brightest group is FIGS. 18A and 18B, darkest group is FIGS. 15A and 15B. Next to the step S410, a plurality of first and second analyzable blocks are extracted from the linear and non-linear images respectively, and then a plurality of first and second gray level values are obtained according to the first and second analyzable blocks in the step S420. The image processing unit extracts the analyzable blocks using a wavelet transformation manner, such as H. Tong, M. Li, H. Zhang, J. He, and C. Zhang. “Blur detection for digital images using wavelet transform.” In Proceedings of International Conference on Multimedia and Expo, 2004. Further, the image processing unit can extract the analyzable block using a block selecting manner for selecting a preferably analyzable block. In the step S422, the first and second gray level values obtained in the step S420 are merged to a plurality of merged parameters indicated as the pixel intensity distribution of the analyzable blocks.

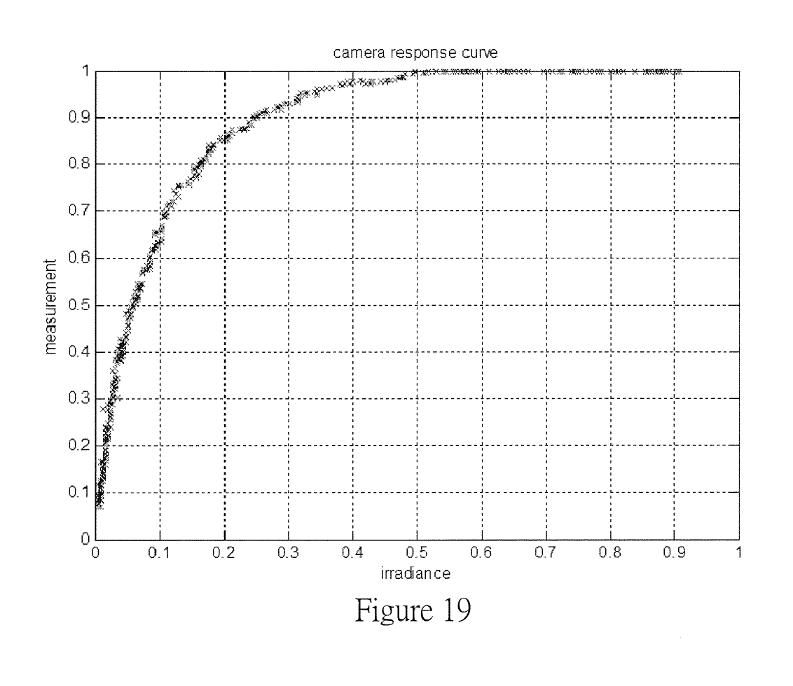

Continuously, in the step S424, a curve of the merged parameters is derived as the pixel intensity distribution of the analyzable blocks. Then, in the step S430, as shown in the FIG. 19, a plurality of CRF parameters are obtained according to the merged parameters using equation (1) for obtaining a CRF curve. Therefore, the present invention not only makes the image processing unit can easily estimate the image conversion parameters according to the irradiance change of the object, but also make the image processing unit enhance the estimation quality.

To sum up, the present invention provides a method for estimating image conversion parameters by using an edge feature characteristic of a captured image. The present invention can take linear brightness change of a single captured image to estimate the image conversion parameters, also can take the comparison of linear and non-linear images to estimate the image conversion parameters, further can take the difference of exposure quantities to estimate the image conversion parameters. Therefore, the image conversion parameter estimation can be finished well and easily.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A method for estimating image conversion parameters, comprising the steps of:
capturing a captured image from an object by an image capturing unit;
analyzing an edge feature of the captured image to obtain a plurality of gray level values of the captured image; and
estimating a plurality of image conversion parameters for converting a camera image according to the gray level values.

2. The method as claimed in claim 1, further comprising the step of:
extracting a analyzable block from the captured image, the analyzable block containing the edge feature.

3. The method as claimed in claim 1, further comprising the step of:
deriving a curve according to the gray level values.

4. The method as claimed in claim 3, wherein the step of estimating a plurality of image conversion parameters according to the gray level values, the image processing unit estimates the image conversion model from a linear segment of the curve.

5. The method as claimed in claim 3, wherein the step of estimating a plurality of image conversion parameters according to the gray level values, the curve is normalized for that a plurality of pixel values of the captured image are converted to be a plurality of irradiance of the captured image, and a plurality of image intensities of the captured image are converted to be the image conversion parameters.

6. A method for estimating image conversion parameters, comprising the steps of:
capturing a linear image and a non-linear image, from an object by an image capturing unit;
analyzing the captured image and the non-linear image to obtain a plurality of first and second gray level values;
comparing the first and second gray level values to obtain a plurality of comparison results; and
estimating a plurality of image conversion parameters for converting an camera image according to the comparison results.

7. The method as claimed in claim 6, further comprising the step of:
extracting the first and second analyzable blocks from the captured image and the non-linear image, respectively; and
analyzing the first and second analyzable blocks to the plurality of first and second gray level values.

8. The method as claimed in claim 6, further comprising the step of:
deriving a plurality of curves according to the values of the first and second gray level values.

9. A method for estimating image conversion parameters, comprising the steps of:
the image capturing unit capturing a plurality of captured images from an object to the image processing unit, the captured images having different exposure quantities;
analyzing the captured images to obtain a plurality of gray level values;
merging the gray level values related to different exposure quantities to obtain a plurality of merged parameters; and
estimating a plurality of image conversion parameters for converting a camera image according to the merged parameters.

10. The method as claimed in claim 9, further comprising the step of:
extracting a plurality of analyzable blocks from the captured images.

11. The method as claimed in claim 9, further comprising the step of:
deriving a plurality of curves according to the gray level values.

12. The method as claimed in claim 9, wherein the step of merging the gray level values to obtain a plurality of merged parameters, the image processing unit merges a plurality of curves related to the gray level values to obtain a merged curve related to the merged parameters.

13. The method as claimed in claim 12, wherein the step of estimating image conversion parameters according to the combined function, the image processing unit estimates the image conversion parameters according to a linear segment of the merged curve.

14. The method as claimed in claim 12, wherein the step of estimating a plurality of image conversion parameters for converting a camera image according to the merged parameters, the merged curve is normalized for estimating the image conversion parameters; wherein the merged curve are converted to be a plurality of irradiances of the merged curve.

15. The method as claimed in claim 9, further comprising the step of:
deriving a curves according to the merged parameters.
